(19) United States
(12) Patent Application Publication
(10) Pub. No.: US 2020/0025652 A1
(43) Pub. Date: Jan. 23, 2020

(54) INFORMATION PROCESSING DEVICE, INFORMATION PROCESSING METHOD, AND STORAGE MEDIUM

(71) Applicant: NEC Corporation, Minato-ku, Tokyo (JP)

(72) Inventor: Etsushi YOSHIDA, Tokyo (JP)

(73) Assignee: NEC Corporation, Minato-ku, Tokyo (JP)

(21) Appl. No.: 16/481,530

(22) PCT Filed: Feb. 19, 2018
(86) PCT No.: PCT/JP2018/005703

§ 371 Date: Jul. 29, 2019

(30) Foreign Application Priority Data
Feb. 20, 2017 (JP) 2017-029029

(51) Int. Cl. G01M 99/00

(52) U.S. Cl. CPC G01M 99/008

(57) ABSTRACT

In order to reduce the cost of pinging, this information processing device is characterized by being equipped with: a data reception unit that receives data from a device being monitored; an abnormality inference unit that, on the basis of a data reception status indicating that the data reception unit has received the data, infers an abnormality of the device being monitored; and a diagnosis instruction unit that issues an instruction for starting a device diagnosis when the abnormality inference unit infers that there is an abnormality in the device being monitored.

### TECHNICAL FIELD

The present invention relates to an information processing device, an information processing method, and an information processing program.

### BACKGROUND ART

PTLs 1 to 3 disclose a technique for measuring a deterioration situation of a device by using measured data from a sensor, and performing a failure diagnosis.

Further, PTL 4 discloses a technique for performing alive monitoring by Ping regularly, and performing a failure determination, based on failure information.

### CITATION LIST

### Patent Literature

[PTL 1] Japanese Unexamined Patent Application Publication No. 2015-063298

[PTL 2] Japanese Unexamined Patent Application Publication No. 2012-242985

[PTL 3] Japanese Unexamined Patent Application Publication No. 2011-230634

[PTL 4] Japanese Unexamined Patent Application Publication No. 2016-095610

### SUMMARY OF INVENTION

### Technical Problem

The techniques described in PTLs described above are not a technique for suppressing a cost of performing alive monitoring.

One object of the present invention is to provide a technique for suppressing a cost of performing alive monitoring.

### Solution to Problem

In order to achieve the above-described object, a device according to one aspect of the present invention is an information processing device including a data reception means for receiving data from a monitoring target device, an abnormality estimation means for estimating an abnormality of the monitoring target device, based on a data reception situation in which the data reception means has received the data, and a diagnosis instruction means for providing an instruction for starting a device diagnosis when the abnormality estimation means estimates that there is an abnormality in the monitoring target device.

In order to achieve the above-described object, a method according to one aspect of the present invention includes receiving data from a monitoring target device, estimating an abnormality of the monitoring target device, based on a data reception situation in which the data have been received, and providing an instruction for starting a device diagnosis when it is estimated that there is an abnormality in the monitoring target device.

In order to achieve the above-described object, a storage medium according to one aspect of the present invention stores an information processing program causing a computer to execute data reception processing of receiving data from a monitoring target device, abnormality estimation processing of estimating an abnormality of the monitoring target device, based on a data reception situation in which the data have been received by the data reception processing, and diagnosis instruction processing of providing an instruction for starting a device diagnosis when it is estimated that there is an abnormality in the monitoring target device by the abnormality estimation processing.

### Advantageous Effects of Invention

The present invention is able to suppress a cost of performing alive monitoring.

### BRIEF DESCRIPTION OF DRAWINGS

FIG. 1A is a block diagram illustrating a configuration of an information processing device according to a first example embodiment of the present invention.

FIG. 1B is a flowchart illustrating a flow of processing of the information processing device according to the first example embodiment.

FIG. 2 is a block diagram illustrating a configuration of an information processing device according to a second example embodiment of the present invention.

FIG. 3A is a diagram illustrating one example of data stored in a reception history database.

FIG. 3B is a diagram illustrating one example of data stored in a trend information database.

FIG. 4 is a flowchart illustrating a flow of processing of the information processing device according to the second example embodiment of the present invention.

FIG. 5 is a diagram illustrating one example of a notification characteristic of a monitoring target device monitored by an information processing device according to a third example embodiment of the present invention.

FIG. 6 is a diagram illustrating one example of a graph of an expected value accumulation, based on the notification characteristic of the monitoring target device monitored by the information processing device according to the third example embodiment of the present invention.

FIG. 7 is a flowchart illustrating a flow of processing of the information processing device according to the third example embodiment of the present invention.

FIG. 8 is a block diagram illustrating one example of a computer system that may achieve the present invention.

### EXAMPLE EMBODIMENT

Hereinafter, example embodiments of the present invention are exemplarily described in detail with reference to the drawings. However, a component described in the example embodiments below is merely an exemplification, and a technical scope of the present invention is not intended to be limited to the component.

### First Example Embodiment

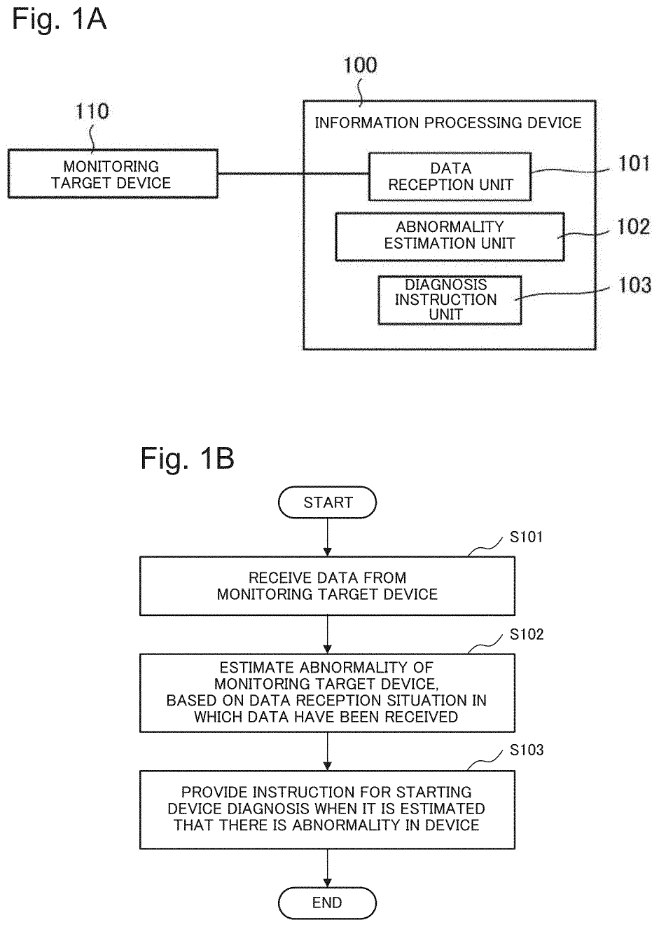

An information processing device 100 as a first example embodiment of the present invention is described by using FIG. 1A. The information processing device 100 is a device that estimates an abnormality of a monitoring target device 110.

As illustrated in FIG. 1A, the information processing device 100 includes a data reception unit 101, an abnormality estimation unit 102, and a diagnosis instruction unit 103.

The data reception unit 101 receives data from the monitoring target device.

The abnormality estimation unit 102 estimates an abnormality of the monitoring target device 110, based on a data reception situation in which the data reception unit 101 has received the data.

When the abnormality estimation unit 102 determines that there is an abnormality in the monitoring target device 110, the diagnosis instruction unit 103 provides an instruction for starting a device diagnosis.

A flow of processing by the information processing device 100 according to the first example embodiment is described with reference to a flowchart in FIG. 1B. In Step S101, the data reception unit 101 receives data from the monitoring target device. Then, the abnormality estimation unit 102 estimates an abnormality of the monitoring target device 110, based on a data reception situation in which the data reception unit 101 has received the data (Step S102). When the abnormality estimation unit 102 determines that there is an abnormality in the monitoring target device 110, the diagnosis instruction unit 103 provides an instruction for starting a device diagnosis (Step S103).

According to the present example embodiment, a device diagnosis is performed after an abnormality estimation is performed, based on a data reception situation from the monitoring target device, and thus a cost of performing alive monitoring can be suppressed.

### Second Example Embodiment

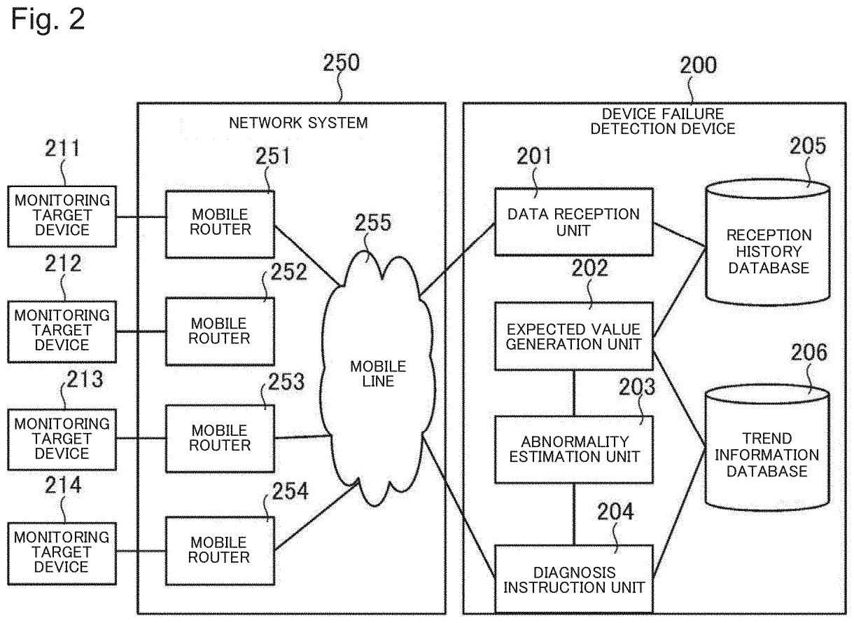

Next, a device failure detection device 200 as an information processing device according to a second example embodiment of the present invention is described by using FIG. 2. FIG. 2 is a diagram illustrating a configuration of the device failure detection device 200 according to the present example embodiment.

Data transmitted from monitoring target devices 211 to 214 are transmitted to the device failure detection device 200 via a mobile line 255 by using mobile routers 251 to 254.

Examples of the monitoring target devices 211 to 214 include a vending machine (such as a toy) and an observation device of a natural phenomenon (such as volcanic activity of an active volcano, an outbreak of insect pests, and flying migrants). Note that, a connection with the mobile line 255 is one example, and a combination of a fixed communication network and a wireless LAN or a low-power wireless communication means may be used.

The device failure detection device 200 is connected to the monitoring target devices 211 to 214 via a network system 250. The device failure detection device 200 includes a data reception unit 201, an expected value generation unit 202, an abnormality estimation unit 203, a diagnosis instruction unit 204, a reception history database 205, and a trend information database 206.

In the device failure detection device 200, the data reception unit 201 receives data from the monitoring target devices 211 to 214, and accumulates the received data in the reception history database 205. The expected value generation unit 202 refers a data reception history in the reception history database 205 and trend information (such as fluctuations due to a season, fluctuations due to a difference between a weekday and a holiday, and fluctuations due to a time zone) related to a notification occurrence frequency in the trend information database 206, and generates expected value information related to a data reception frequency at each point of time. In other words, the expected value generation unit 202 derives an expected value of a reception frequency of data for each predetermined time zone, based on a reception situation of the data and information concerned with a trend in the reception frequency of the data, and generates information indicating the expected value. Note that a frequency is synonymous with the “number of occurrence times within a predetermined period of time”.

When a monitoring target event (that is, an event that causes the monitoring target devices 211 to 214 to transmit data) has an avalanche effect (that is, a trend that a probability of occurrence is normally low, but once an event occurs, a probability of consecutive occurrence is increased), an expected value is set to low in a non-notification period (that is, a period during which a notification has not occurred for a while), and once a notification occurs, an expected value in a subsequent time zone may be modified to a higher value.

Furthermore, the abnormality estimation unit 203 measures, from an accumulation of a difference between an expected value of the number of occurrence times of an event (that is, an expected value of a reception frequency of data) and reception history information (that is, an actual history of reception of data, namely, an actual value of a reception frequency of data), a degree of a gap between the expected value and the actual value, and determines a possibility of a device abnormality (that is, presence of an abnormality in a device). In other words, the abnormality estimation unit 203 measures a degree of a gap between the expected value and the actual value from an accumulation of a difference between the expected value and the actual value, and determines that there is a device abnormality in a stage where this degree exceeds a previously set threshold value. When receiving this signal (signal indicating that the abnormality estimation unit 203 has determined that there is a device abnormality), the diagnosis instruction unit 204 provides an instruction for starting a diagnosis procedure.

One example of a method of estimation by the abnormality estimation unit 203 is described. For example, when an actual value of reception of data does not exceed a threshold value acquired from an accumulation value of an expected value of a reception frequency of the data, the abnormality estimation unit 203 estimates that an abnormality has occurred in a monitoring target device.

For example, when data reception from a monitoring target device occurs at intervals of less than or equal to 20 minutes on a business day of a monitoring target store, a threshold value is set from an expected value of the number of notification reception times until 20 minutes after the data reception, and the abnormality estimation unit 203 may estimate a device abnormality in a case where there is no data reception for 20 minutes.

For example, when data reception from a monitoring target device occurs at intervals of one minute for 20 minutes on a business day of a monitoring target store, a threshold value may be set to be 19 times from an expected value of an accumulation of the number of notification reception times until 20 minutes after the data reception. Then, the abnormality estimation unit 203 estimates a device abnormality when an accumulation of an actual value for 20 minutes falls below the threshold value of 19 times.

Another example of a method of estimation by the abnormality estimation unit 203 is described. For example, when data reception from a monitoring target device occurs at a frequency of once in 20 minutes on a business day of a monitoring target store, an expected value at every 20 minutes is once. When there is no reception of data for some 20 minutes in a case where a threshold value is set to be a value smaller than “once”, a difference between the expected value (once) and the actual value (0 time) exceeds the threshold value, and thus the abnormality estimation unit 203 estimates a device abnormality.

Herein, when it is known that there are fluctuations at an occurrence time of a notification, timing of determination of an exceeded threshold value (that is, timing of determining whether a degree of a gap between an expected value and an actual value exceeds a threshold value) may be delayed by a maximum value of the fluctuations in order to prevent false abnormality estimation due to the fluctuations.

Further, timing of determination of an exceeded threshold value may be advanced by diagnosis and treatment time in order to reduce device non-operating time including the diagnosis and treatment time after abnormality estimation to less than or equal to an allowable maximum value.

The diagnosis instruction unit 204 provides an instruction for starting a diagnosis procedure to any of the monitoring target devices 211 to 214 determined as abnormal by the abnormality estimation unit 203. Specifically, for example, the diagnosis instruction unit 204 performs a remote diagnosis (such as a Ping diagnosis) on any of the monitoring target devices 211 to 214. Alternatively, the diagnosis instruction unit 204 may notify an operator of the monitoring target device of the monitoring target devices 211 to 214 in which an abnormality is estimated, and provide an instruction for a diagnosis operation.

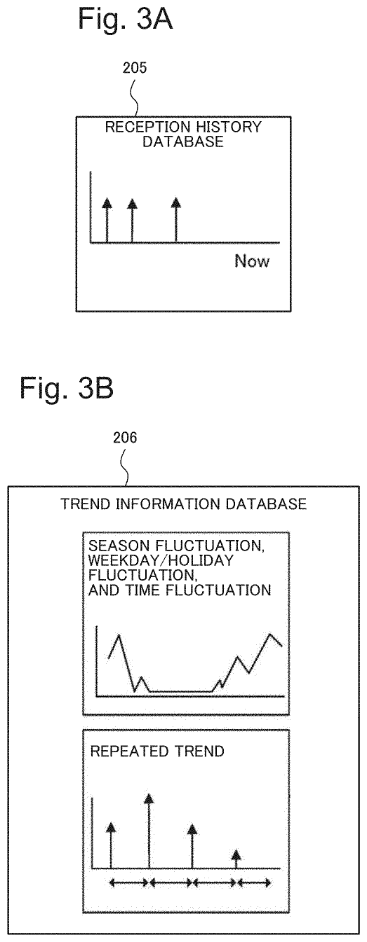

FIG. 3A illustrates one example of data stored in the reception history database 205. The reception history database 205 stores a data reception history (series of reception data and time, and time) input from the data reception unit 201.

FIG. 3B illustrates one example of data stored in the trend information database 206. The trend information database 206 stores a data reception trend given as an external input in form of a probability distribution indicating fluctuations in a periodical reception probability, a probability distribution indicating a trend that data reception repeatedly occurs, and the like. For example, a probability distribution is stored in such a way that a probability that reception repeats (that is, reoccurs) between 0 and 1 time slots is 20%, a probability that reception repeats between 1 and 2 time slots is 30%, and the like with certain reception as a starting point. Further, the trend information database 206 holds information related to a time zone (for example, 10:00 to 19:00 everyday except Wednesday) in which a device operates, information indicating that there is a trend of receiving data in the same time zone in a cycle of one day, and the like.

The expected value generation unit 202 calculates an expected value by synthesizing (combining) a reception history and trend information.

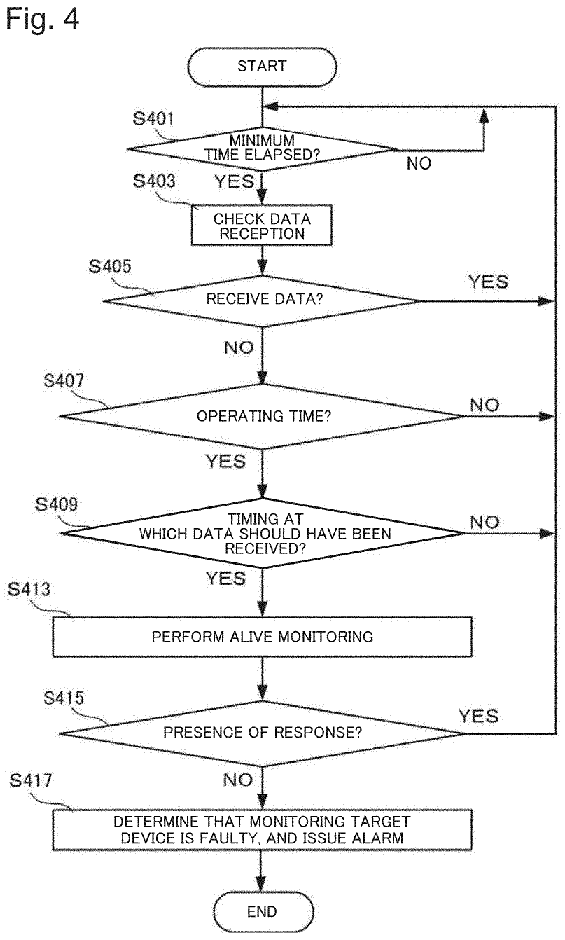

With reference to FIG. 4, an example of a flow of failure detection processing of the device failure detection device 200 is described. First, in Step S401, a lapse of minimum time of a data transmission interval from each of the monitoring target devices 211 to 214 is determined. When the minimum time (for example, 20 minutes) has elapsed, in Step S403, the abnormality estimation unit 203 checks with the data reception unit 201 whether or not the data reception unit 201 has received data from each of the monitoring target devices 211 to 214.

When the data reception unit 201 has received the data from all of the monitoring target devices 211 to 214, the processing returns from Step S405 to Step S401. When the data reception unit 201 has not received the data from any of the monitoring target devices 211 to 214 even though the minimum time (for example, 20 minutes) has elapsed, the processing proceeds from Step S405 to Step S407. In Step S407, the abnormality estimation unit 203 refers to the trend information database 206, and checks whether a time zone in which the data have not been received is a time zone in which the monitoring target device that has not received the data should have been operating. When the time zone in which the data have not been received is the time zone in which the monitoring target device should have been operating, the processing proceeds from Step S407 to Step S409. Then, the abnormality estimation unit 203 refers to the reception history database 205, and checks whether the data have been received in a time zone on a certain day corresponding to the time zone in which the data have not been received. When the data have been received in the above-described time zone, the device failure detection device 200 determines that the “time zone in which the data have not been received is a time zone in which the data should have normally been received”, and the processing proceeds from Step S409 to Step S413.

When the time zone in which the data have not been received is not the time zone in which the monitoring target device that has not received the data should have been operating, or is not the “time zone in which the data should have normally been received”, the processing returns to Step S401, and the data reception check is performed again.

In Step S413, the abnormality estimation unit 203 requests failure separation from the diagnosis instruction unit 204, and the diagnosis instruction unit 204 performs alive monitoring by Ping on the monitoring target device that has not received the data.

Next, in Step S415, the diagnosis instruction unit 204 determines presence or absence of a response from the monitoring target device that has not received the data. When there is no response, the processing proceeds to Step S417, and the device failure detection device 200 determines that the monitoring target device is faulty, and issues an alarm.

The minimum time varies depending on a specification of a monitoring target device and a trend of data reception.

In the present example embodiment, the device failure detection device 200 can minimize a communication cost and device power consumption by estimating an abnormality of a device, based on a data reception situation from each monitoring device and trend information related to notification occurrence of each monitoring device, and providing an instruction for performing a diagnosis on an abnormality estimated device.

### Third Example Embodiment

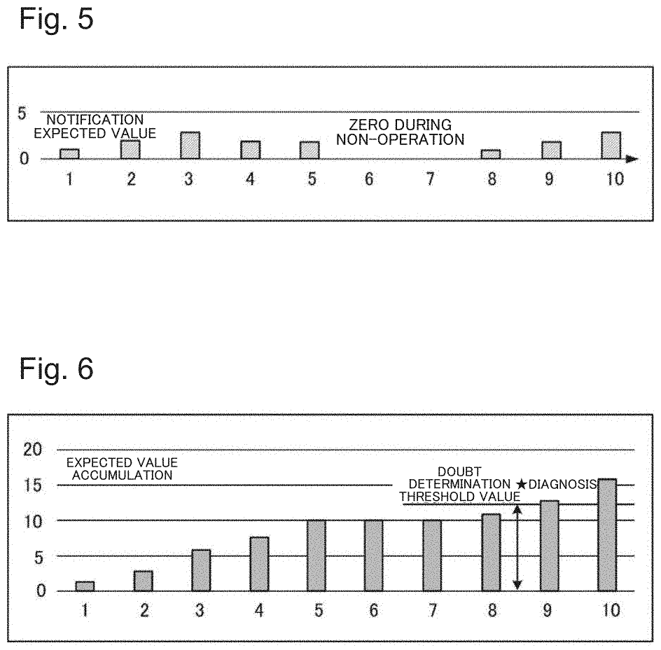

Next, an information processing device according to a third example embodiment of the present invention is described by using FIGS. 5 to 7. It is assumed that a monitoring target device in the present example embodiment is an unattended store, a notification does not occur on a store closed day, and a notification in a determined pattern occurs on a store business day.

FIG. 5 is a diagram for describing a notification characteristic (temporal fluctuations in a notification expected value (that is, an expected value of the number of notification times)) of a monitoring target device monitored by the information processing device according to the present example embodiment. As compared with the second example embodiment described above, the information processing device according to the present example embodiment has a configuration and an operation similar to those in the second example embodiment except for a notification characteristic of a monitoring target device, and thus the same configuration and operation are provided with the same reference signs, and detailed description thereof is omitted.

FIG. 5 is a graph illustrating a change in expected value generated by an expected value generation unit 202. The horizontal axis indicates a time zone (time slot), and the vertical axis indicates an expected value of the number of notification times in the time zone.

FIG. 6 is a graph of an expected value accumulation used when the expected value generation unit 202 determines a threshold value. The horizontal axis indicates a time zone (time slot), and the vertical axis indicates an expected value accumulation, namely, an accumulated value of an expected value of the number of notification times, in the time zone.

A doubt determination threshold value (for example, 13 times for 10 minutes) is previously defined, based on an accumulated value of a notification expected value from the latest notification reception until a current time. When an accumulated value (not illustrated; for example, 12 times for 10 minutes) of an actual value does not exceed the doubt determination threshold value defined in such a manner, an abnormality estimation unit 203 determines that a diagnosis needs to be performed. Herein, an expected value may be set to zero when the store is closed. In this case, an accumulated value of the expected value does not increase while the store is closed. Further, calculation of an expected value in store business hours may be performed, based on a history of a previous day. In other words, the expected value generation unit 202 may generate generation of an expected value, based on data information received in store business hours on a previous day. While the store is open, an accumulated value of the expected value increases at timing of a notification on a previous day (that is, at a time corresponding to a time of a notification on a previous day). As a method of calculating an accumulated value of a notification expected value, any of a method of calculating an accumulated value of a notification expected value every time, a method of estimating a threshold value exceeding time previously by a simulation, and a method of acquiring an accumulated value of a notification expected value with a chart (in a case where calculation is possible only at intervals) may be used.

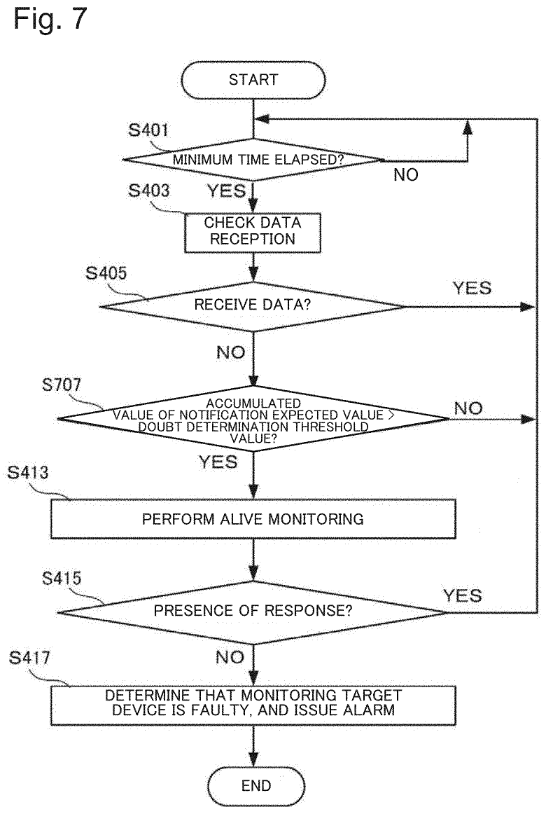

FIG. 7 is a flowchart illustrating a flow of processing in the present example embodiment. The same step as the step in the processing (FIG. 4) of the second example embodiment is provided with the same step number as the step number in the processing of the second example embodiment.

When it is determined that data have not been received in Step S405, the processing proceeds to Step S707, and the expected value generation unit 202 refers to a trend information database 206, and calculates an accumulated value of a notification expected value at a corresponding time (that is, a period in which the data have not been received). Then, the abnormality estimation unit 203 compares the calculated accumulated value of the notification expected value with a doubt determination threshold value. When the accumulated value of the notification expected value exceeds the doubt determination threshold value, the processing proceeds from Step S707 to Step S413, and alive monitoring is performed.

According to the present example embodiment, the information processing device can minimize a communication cost and device power consumption by estimating an abnormality of a device by using an accumulated value of a notification expected value, and performing a diagnosis on an abnormality estimated device.

### Other Example Embodiment

Although the invention of the present application has been described with reference to the example embodiments, the invention of the present application is not limited to the above-described example embodiments. Various modifications that can be understood by those skilled in the art within the scope of the invention of the present application may be applied to the configuration and the details of the above-described example embodiments. Further, a system or a device that combines different features included in the respective example embodiments in any form is also included within the scope of the present invention.

Further, the present invention may be applied to a system including a plurality of apparatuses and may be applied to a single device. Furthermore, the present invention is also applicable to a case where an information processing program achieving functions of the example embodiments is supplied to a system or a device directly or remotely. Therefore, in order to achieve functions of the present invention by a computer, a program installed in the computer, a medium that stores the program, or a World Wide Web (WWW) server that causes the program to be downloaded is also included within the scope of the present invention. In particular, at least a non-transitory computer readable medium that stores a program causing a computer to execute processing included in the above-mentioned example embodiments is included within the scope of the present invention.

Examples of a medium that stores the above-described program include a portable medium such as an optical disk, a magnetic disk, a magneto-optical disk, and a non-volatile semiconductor memory, and a storage device such as a read only memory (ROM) built in a computer system and a hard disk. Furthermore, the “medium” may include a medium that can temporarily hold a program, such as a volatile memory inside a computer system, and a medium that transmits a program, such as a communication line such as a network and a telephone line. Further, the above-described program may achieve a part of the above-mentioned function, and may further achieve the above-mentioned function by a combination with a program already stored in a computer system.

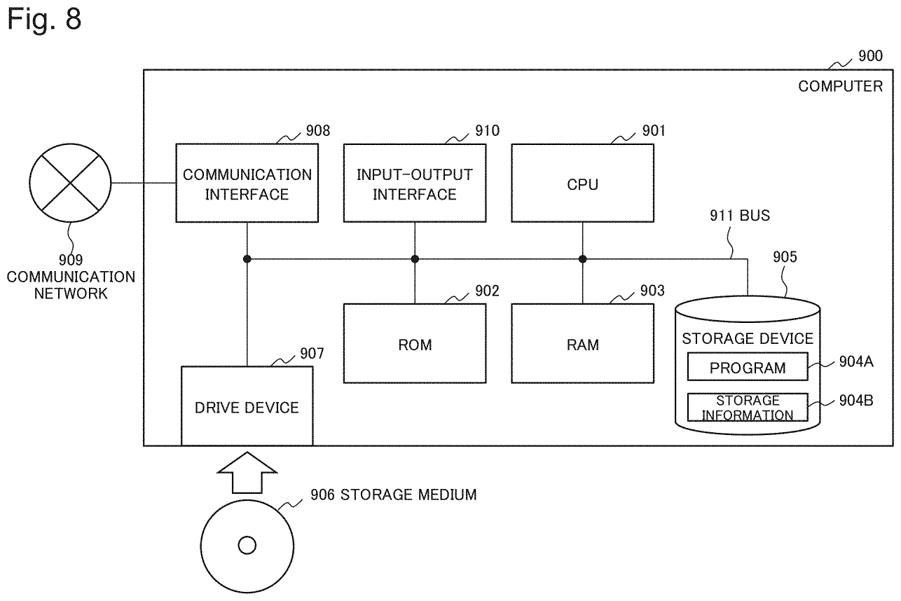

A computer system that may achieve the present invention is a system including a computer 900 as illustrated in FIG. 8 as one example. The computer 900 includes the following configuration.
One or a plurality of central processing units (CPUs) 901
A ROM 902
A random access memory (RAM) 903
A program 904A and storage information 904B loaded into the RAM 903
A storage device 905 that stores the program 904A and the storage information 904B
A drive device 907 that reads and writes a storage medium 906
A communication interface 908 connected to a communication network 909
An input-output interface 910 that inputs and outputs data
A bus 911 that connects components

For example, each of the components of each of the devices in each of the example embodiments is achieved by the CPU 901 loading the program 904A that achieves a function of the component into the RAM 903 and executing the program 904A. The program 904A that achieves a function of each of the components of each of the devices is previously stored in the storage device 905 and the ROM 902, for example. Then, the CPU 901 reads the program 904A as necessary. The storage device 905 is, for example, a hard disk. The program 904A may be supplied to the CPU 901 via the communication network 909, or may be previously stored in the storage medium 906 and read by the drive device 907 to be supplied to the CPU 901. Note that, the storage medium 906 is, for example, a portable medium such as an optical disk, a magnetic disk, a magneto-optical disk, and a non-volatile semiconductor memory.

### [Other Expression of Example Embodiment]

A part or the whole of the above-mentioned example embodiments may also be described as in supplementary notes below, but are not limited thereto.

### [Supplementary Note 1]

An information processing device, including:

a data reception means for receiving data from a monitoring target device;

an abnormality estimation means for estimating an abnormality of the monitoring target device, based on a data reception situation in which the data reception means has received the data; and

a diagnosis instruction means for providing an instruction for starting a device diagnosis when the abnormality estimation means estimates that there is an abnormality in the monitoring target device.

### [Supplementary Note 2]

The information processing device according to supplementary note 1, further including

an expected value generation means for generating information indicating an expected value of a reception frequency of the data from the monitoring target device, wherein

the abnormality estimation means estimates an abnormality of the monitoring target device, based on the data reception situation and the information indicating an expected value.

### [Supplementary Note 3]

The information processing device according to supplementary note 1 or 2, wherein the abnormality estimation means estimates that an abnormality has occurred in the monitoring target device when a difference between an actual value of a number of reception times of the data and an expected value in a certain period exceeds a predetermined threshold value for the monitoring target device.

### [Supplementary Note 4]

The information processing device according to any one of supplementary notes 1 to 3, wherein the abnormality estimation means estimates an abnormality of the monitoring target device, also based on information indicating a trend of data reception from the monitoring target device.

### [Supplementary Note 5]

The information processing device according to any one of supplementary notes 1 to 4, wherein the diagnosis instruction means performs alive monitoring on the monitoring target device when it is estimated that an abnormality has occurred in the monitoring target device.

### [Supplementary Note 6]

An information processing method, including:

receiving data from a monitoring target device;

estimating an abnormality of the monitoring target device, based on a data reception situation in which the data have been received; and

providing an instruction for starting a device diagnosis when it is estimated that there is an abnormality in the monitoring target device.

### [Supplementary Note 7]

The information processing method according to supplementary note 6, further including:

generating information indicating an expected value of a reception frequency of the data from the monitoring target device; and

estimating an abnormality of the monitoring target device, based on the data reception situation and the information indicating an expected value.

### [Supplementary Note 8]

The information processing method according to supplementary note 6 or 7, further including

estimating that an abnormality has occurred in the monitoring target device when a difference between an actual value of a number of reception times of the data and an expected value in a certain period exceeds a predetermined threshold value for the monitoring target device.

### [Supplementary Note 9]

The information processing method according to any one of supplementary notes 6 to 8, further including

estimating an abnormality of the monitoring target device, also based on information indicating a trend of data reception from the monitoring target device.

### [Supplementary Note 10]

The information processing method according to any one of supplementary notes 6 to 9, further including

performing alive monitoring on the monitoring target device when it is estimated that an abnormality has occurred in the monitoring target device.

### [Supplementary Note 11]

A computer-readable storage medium that stores a program causing a computer to execute:

data reception processing of receiving data from a monitoring target device;

abnormality estimation processing of estimating an abnormality of the monitoring target device, based on a data reception situation in which the data have been received by the data reception processing; and

diagnosis instruction processing of providing an instruction for starting a device diagnosis when it is estimated that there is an abnormality in the monitoring target device by the abnormality estimation processing.

### [Supplementary Note 12]

The storage medium according to supplementary note 11, wherein

the program further causes a computer to execute expected value generation processing of generating information indicating an expected value of a reception frequency of the data from the monitoring target device, and

the abnormality estimation processing estimates an abnormality of the monitoring target device, based on the data reception situation and the information indicating an expected value.

### [Supplementary Note 13]

The storage medium according to supplementary note 11 or 12, wherein the abnormality estimation processing estimates that an abnormality has occurred in the monitoring target device when a difference between an actual value of a number of reception times of the data and an expected value in a certain period exceeds a predetermined threshold value for the monitoring target device.

### [Supplementary Note 14]

The storage medium according to any one of supplementary notes 11 to 13, wherein the abnormality estimation processing estimates an abnormality of the monitoring target device, also based on information indicating a trend of data reception from the monitoring target device.

### [Supplementary Note 15]

The storage medium according to any one of supplementary notes 11 to 14, wherein the diagnosis instruction processing performs alive monitoring on the monitoring target device when it is estimated that an abnormality occurs in the monitoring target device.

This application is based upon and claims the benefit of priority from Japanese Patent Application No. 2017-029029, filed on Feb. 20, 2017, the disclosure of which is incorporated herein in its entirety by reference.

What is claimed is:

1. An information processing device, comprising:
data reception unit receiving data from a monitoring target device;
abnormality estimation unit estimating an abnormality of the monitoring target device, based on a data reception situation in which the data reception unit has received the data; and
diagnosis instruction unit providing an instruction for starting a device diagnosis when the abnormality estimation unit estimates that there is an abnormality in the monitoring target device.

2. The information processing device according to claim 1, further comprising
expected value generation unit generating information indicating an expected value of a reception frequency of the data from the monitoring target device, wherein
the abnormality estimation unit estimates an abnormality of the monitoring target device, based on the data reception situation and information indicating the expected value.

3. The information processing device according to claim 1, wherein
the abnormality estimation unit estimates that an abnormality has occurred in the monitoring target device when a difference between an actual value of a number of reception times of the data and an expected value in a certain period exceeds a predetermined threshold value for the monitoring target device.

4. The information processing device according to claim 1, wherein
the abnormality estimation unit estimates an abnormality of the monitoring target device, also based on information indicating a trend of data reception from the monitoring target device.

5. The information processing device according to claim 1, wherein
the diagnosis instruction unit performs alive monitoring on the monitoring target device when it is estimated that an abnormality has occurred in the monitoring target device.

6. An information processing method, comprising:
receiving data from a monitoring target device;
estimating an abnormality of the monitoring target device, based on a data reception situation in which the data have been received; and
providing an instruction for starting a device diagnosis when it is estimated that there is an abnormality in the monitoring target device.

7. The information processing method according to claim 6, further comprising:
generating information indicating an expected value of a reception frequency of the data from the monitoring target device; and
estimating an abnormality of the monitoring target device, based on the data reception situation and information indicating the expected value.

8. The information processing method according to claim 6, further comprising
estimating that an abnormality has occurred in the monitoring target device when a difference between an actual value of a number of reception times of the data and an expected value in a certain period exceeds a predetermined threshold value for the monitoring target device.

9. The information processing method according to claim 6, further comprising
estimating an abnormality of the monitoring target device, also based on information indicating a trend of data reception from the monitoring target device.

10. The information processing method according to claim 6, further comprising
performing alive monitoring on the monitoring target device when it is estimated that an abnormality has occurred in the monitoring target device.

11. A computer-readable storage medium that stores a program causing a computer to execute:
data reception processing of receiving data from a monitoring target device;
abnormality estimation processing of estimating an abnormality of the monitoring target device, based on a data reception situation in which the data have been received by the data reception processing; and
diagnosis instruction processing of providing an instruction for starting a device diagnosis when it is estimated that there is an abnormality in the monitoring target device by the abnormality estimation processing.

12. The storage medium according to claim 11, wherein
the program further causes a computer to execute expected value generation processing of generating information indicating an expected value of a reception frequency of the data from the monitoring target device, and
the abnormality estimation processing estimates an abnormality of the monitoring target device, based on the data reception situation and information indicating the expected value.

13. The storage medium according to claim 11, wherein
the abnormality estimation processing estimates that an abnormality has occurred in the monitoring target device when a difference between an actual value of a number of reception times of the data and an expected value in a certain period exceeds a predetermined threshold value for the monitoring target device.

14. The storage medium according to claim 11, wherein
the abnormality estimation processing estimates an abnormality of the monitoring target device, also based on information indicating a trend of data reception from the monitoring target device.

15. The storage medium according to claim 11, wherein
the diagnosis instruction processing performs alive monitoring on the monitoring target device when it is estimated that an abnormality has occurred in the monitoring target device.
